(19) United States
(12) Patent Application Publication
(10) Pub. No.: US 2012/0203647 A1
(43) Pub. Date: Aug. 9, 2012

(54) METHOD OF AND SYSTEM FOR UNIQUELY RESPONDING TO CODE DATA CAPTURED FROM PRODUCTS SO AS TO ALERT THE PRODUCT HANDLER TO CARRY OUT EXCEPTION HANDLING PROCEDURES

(75) Inventor: Taylor Smith, Charlotte, NC (US)

(73) Assignee: Metrologic Instruments, Inc.

(21) Appl. No.: 13/023,674

(22) Filed: Feb. 9, 2011

(51) Int. Cl. G06Q 30/00

(52) U.S. Cl. 705/23

(57) ABSTRACT

A code reading system capable of signaling exception handling procedures for products being handled in a work environment, such as, for example, consumer product being purchased in a retail store or a product or package being sorted by a logistics company. The system includes a system housing containing one or more one or more signal sources for generating distinctive visual and/or audible exception handling signals for special classes of products identified in the environment. Such special products may include: EAS tagged products requiring EAS tag deactivation: alcohol and tobacco products requiring proof of age; controlled products requiring additional customer tracking; age restricted products requiring identification; product purchases requiring personnel to show up and approve or assist in a product transaction; and the like.

### BACKGROUND

1. Field of Disclosure

The present disclosure relates to improvements in code reading systems that provide improved levels of intelligence and communication during product handling operations in diverse work environments.

2. Brief Description of the State of the Art

The use of code symbol reading systems in retail environments is well known in the art. Bar code symbols are read at the point of sale (POS) for quickly accessing product price information from the retailers product/price database system, and expediting product checkout operations.

In addition to bearing UPC bar code symbols, some consumer products are tagged with EAS tags to provide increased levels of security within the retail store environment. Alcohol-based products and tobacco-based products that have age-restrictions, require that the consumer provide proof of proper age limit before the cashier is permitted by law to sell the product to the customer.

Currently, some high-end POS terminals are capable of generating an alarm on the POS station monitor whenever alcohol or tobacco products are scanned, for the purpose of alerting the cashier to ask for proper age identification prior to purchase. However, oftentimes the monitor is not in view of the cashier and the alert goes unnoticed at the POS terminal, and thus some retail operations fail to comply with state and federal laws.

Thus, there is a great need in the art for new and improved ways of informing cashiers, when particular consumer products are being purchased, that special handling or exception procedures must be faithfully carried out at the POS, while overcoming the shortcomings and drawbacks of prior art systems and methodologies.

### OBJECTS AND SUMMARY OF THE PRESENT DISCLOSURE

Accordingly, a primary object of the present disclosure is to provide a novel method of and apparatus for informing the handlers of products when special handling or exception handling procedures should be faithfully carried out in a work environment, while avoiding the shortcomings and drawbacks of prior art system and methodologies.

Another object of the present disclosure is to provide a new and improved optical and electronic code reading system for use in diverse work environments, and having the capacity to automatically generate distinctive exception handling signals from sources within the system housing so as to effectively and reliably inform the handler to carry out special handling procedures in accordance with policy and/or state and federal law.

Another object is to provide such a code reading system, wherein the distinctive exception handling signals are generated from sources within the system housing, for special classes of products including, but not limited to: (i) EAS tagged products requiring EAS tag deactivation upon product purchase completion; (ii) alcohol products requiring proof of age (Drivers ID)—age restrictions; (iii) tobacco products requiring proof of age (Drivers ID)—age restrictions; (iv) controlled products requiring additional customer tracking; (v) age restricted products (e.g. spray paint, firearms, ammunition) requiring identification; (vi) product purchases requiring a manager to show up and approve or assist in a product transaction; (vii) product purchases involving the purchase of services, requiring a special service agent to come to the POS to explain the service contract to the customer; (viii) special product purchases requiring store security to assist moving the purchased product out of store inventory; and (ix) product purchases requiring sales clerk to offer other services to customer, including extended product warranties.

Another object is to provide such a code reading system, wherein the distinctive exception handling signals are generated from sources within the system housing, to indicate one or more of following signaling events: (i) generation of an audible response (e.g. signals that change tone, duration or count, or songs or speech-type audio messages produced from a suitable audio-transducer, and/or vibrations or razzle sounds produced from within the hand-supportable housing of the code symbol reading system by way of an electro-mechanical vibrator; and (ii) generation of light patterns from LEDs mounted on the scanner housing, or visual messages displayed on a LCD display mounted on the system housing.

Another object is to provide such a code reading system, wherein the handler (e.g. cashier or retail store manager) uses a special PC utility program to set the special response and handling procedures in the code reading system, for each special product identified by its optically-encoded and/or electronically-encoded code (e.g. UPC, SKU, or EPC).

Another object is to provide such a code reading system, wherein the PC utility is a GUI-based configuration tool, running on the host system, while the host system is interfaced with the code reading system, by way of an interface driver, allowing the user to list, in an Excel spreadsheet or like document, all desired code numbers in a particular class of products (e.g. alcohol products), and corresponding response and handling procedures (e.g. beep duration, frequency and repetition), and wherein the file is exported in a proper output format, into the system memory of the code reading system deployed in the retail environment.

Another object is to provide such code reading systems, each of which automatically generates distinctive exception handling signals from their system housings, in response to reading code symbols (e.g. UPC, EAN, SKU or EPC), for the purpose of effectively signifying the requirement of special handling procedures to be carried out in accordance with retail store policy and/or state and federal law.

Another object to provide an improvement method that can be practiced using bi-optic laser scanning code reading systems, projection-type laser scanning code reading systems, fixed-type laser scanning code reading systems, hand-supportable digital imaging code reading systems, mobile optical code reading systems, and electronic code (e.g. RFID device) reading systems.

Another object is to provide a code reading system that allows the store manager or cashier to easily load data records for all products in a first special product category (e.g. cigarettes) under one SKU listing, while the data records for all products classified under a second special product category (e.g. alcohol products) can be loaded under another SKU listing, so that the store manager or cashier can then simply configure the code symbol reader (e.g. optical bar code reader, EPC RFID reader, etc) to generate a “good read” beep sound from the reader for all products that are not cigarettes or alcoholic, and when a cigarette SKU is scanned and detected in the first SKU listing, then the bar code symbol reader automatically generates a different sound (e.g. a double beep), and when an alcoholic SKU is scanned, then the code symbol reader automatically generates another different sound (e.g. 3 beeps or change the tone of the double beep), to signal the requirement of a special handling procedure for the special product being purchased at the POS.

Another object is to provide a multi-function optical and/or electronic code reading system offering a significantly improved way of and means for allowing retailers and others to comply with policy as well as state and federal law.

Another object is to provide a mobile hand-supportable optical and electronic code reading system, supporting automatic generation of distinctive exception handling signals from multiple sources within its system housing, while being used in virtually any mobile application environment.

These and other objects of the present disclosure will become more apparently understood hereinafter and in the Claims appended hereto.

### BRIEF DESCRIPTION OF THE DRAWINGS

In order to more fully understand the Objects, the following Detailed Description of the Illustrative Embodiments should be read in conjunction with the accompanying Drawings, wherein:

FIG. 1 is a perspective view of an illustrative embodiment of the hand-supportable optical and electronic code reading system supporting automatic generation of distinctive exception handling signals from multiple sources within the system housing;

FIG. 2A is a first perspective exploded view of the multi-function optical and electronic code reading system of the illustrative embodiment depicted in FIG. 1, showing its printed circuit (PC) board assembly arranged between the front and rear portions of the system housing, with the hinged base being pivotally connected to the rear portion of the system housing by way of an axle structure;

FIG. 2B is a second perspective/exploded view of the optical and electronic code reading system of the illustrative embodiment shown in FIG. 1;

FIG. 2C is a plan view of the rear side of the RFID/EAS enabling faceplate bezel employed in the optical and electronic code reading system of FIG. 1, shown removed from the optical and electronic code reading system of FIG. 1;

FIGS. 3A1 and 3A2, taken together, show a schematic block diagram describing the major system components of the multi-function optical and electronic code reading system illustrated in FIGS. 1 through 2B;

FIG. 3B is a schematic representation showing the EAS subsystem and RFID subsystems embedded within the optical and electronic code symbol reading system of FIG. 1;

FIG. 4 is a schematic representation of special product/response exception handling table programmed into the system memory of the optical and electronic code symbol reading system of the first illustrative embodiment shown in FIGS. 1 through 3B;

FIGS. 5A through 5D, taken together, set forth a flow chart describing the primary steps carried out when practicing the method of programming special product codes and responses and handling procedures in the optical and RFID code symbol reading system of FIG. 1;

FIG. 6 is a perspective view of a POS station, in which a multi-function optical and electronic code symbol reading system of a second illustrative embodiment has been installed, supporting automatic generation of distinctive exception handling signals from sources within the system housing, in response to the reading of special product codes (e.g. UPC, EAN, SKU or EPC) encoded optically in bar code symbols and/or electronically in RFID devices (e.g. tags) applied to such products;

FIG. 7 is a perspective view of the optical and electronic code reading system of FIG. 6, shown removed from its POS station;

FIGS. 8A through 8C, taken together, shows a schematic block diagram describing the major system components of the optical and electronic code symbol reading system illustrated in FIGS. 6 and 7, including EAS and RFID subsystems, integrated within the optical and electronically code reading system shown in FIGS. 6 and 7;

FIG. 9 is a schematic representation of special product/response exception handling table programmed into the system memory of the optical and electronic code reading system of the second illustrative embodiment shown in FIGS. 6 through 8C;

FIGS. 10A through 10D, taken together, show a flow chart describing the primary steps carried out when practicing the method of programming special product codes and responses and handling procedures, in the optical and RFID code symbol reading system of FIG. 6;

FIG. 11 is a perspective view of a third illustrative embodiment of a mobile hand-supportable optical and electronic code reading system, supporting automatic generation of distinctive exception handling signals from multiple sources within the system housing; and

FIGS. 12A and 12B, taken together, show a schematic block diagram describing the major system components of the mobile multi-function optical and electronic code reading system illustrated in FIG. 11.

### DETAILED DESCRIPTION OF THE ILLUSTRATIVE EMBODIMENTS

Referring to the figures in the accompanying Drawings, the illustrative embodiments of a multi-function code reading system and method will be described in great detail, wherein like elements will be indicated using like reference numerals.

As used herein and in the Claims, the term “code” shall include (i) optically-encoded codes such as 1D and 2D bar code symbols, datamatrix symbols and other dataforms, as well as (ii) electronically-encoded codes such as electronic product codes (EPCs) and other product and/or service identifiers electronically encoded within RFID devices (e.g. tags, labels, and the like).

### First Illustrative Embodiment of the Optical and Electronic Code Reading System of the Present Disclosure

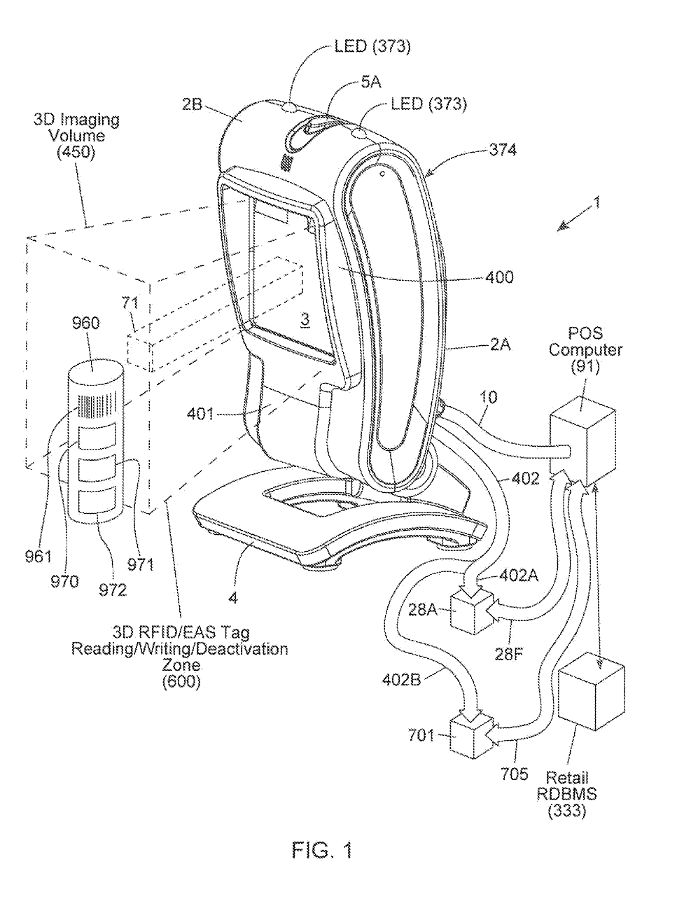

Referring now to FIGS. 1 through 4, a first illustrative embodiment of a hand-supportable optical and electronic code reading system 1 will be described in detail.

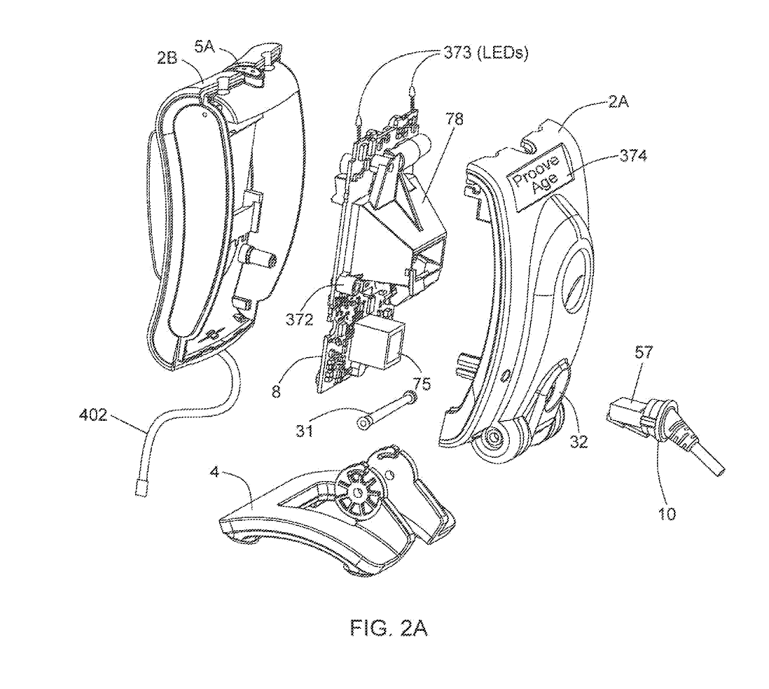

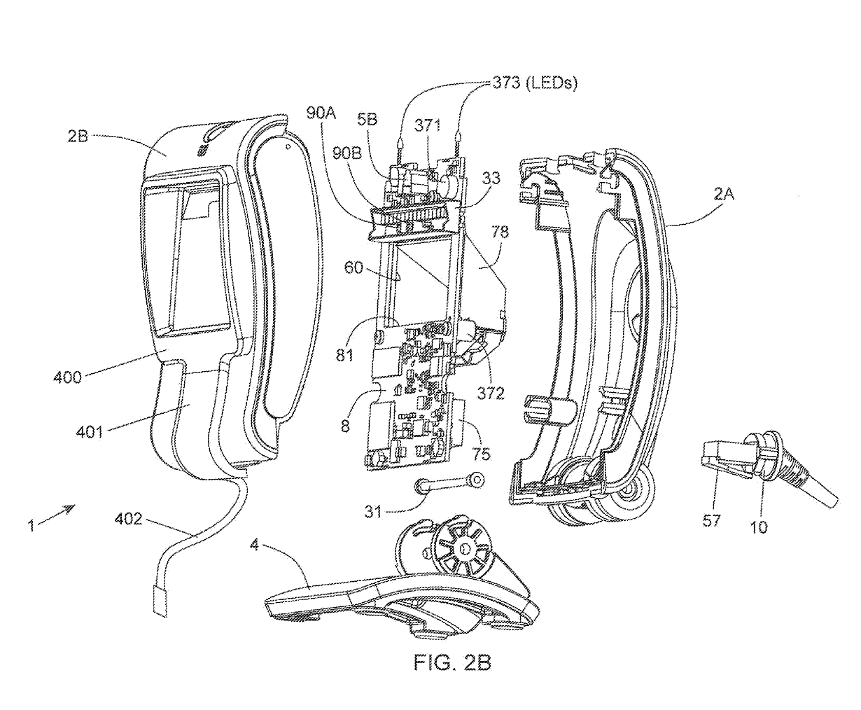

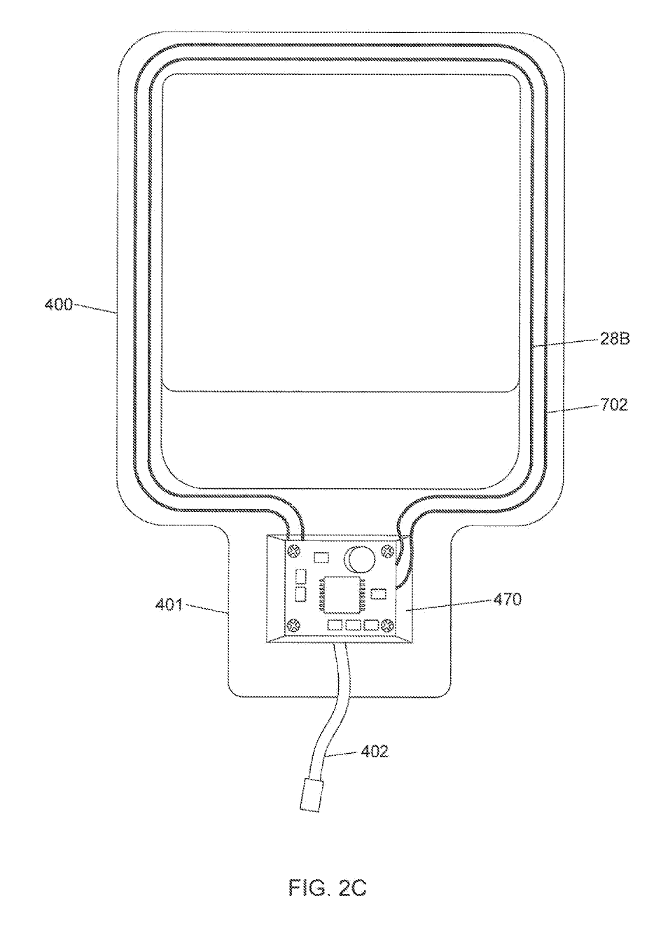

As shown in FIGS. 1, 2 and 2B, the optical and electronic code reading system 1 comprises: a hand-supportable housing 2 having (i) a front housing portion 2B with a window aperture 6 and an imaging window panel (i.e. faceplate) 3 installed therein; and (ii) a rear housing portion 2A. As shown, a single PC board based optical bench 8 (having optical subassemblies mounted thereon) is supported between the front and rear housing portions 2A and 3B which, when brought together, form an assembled unit. A base portion 4 is connected to the assembled unit by way of a pivot axle structure 31 that passes through the bottom portion of the housing and the base portion so that the hand-supportable housing and base portion are able to rotate relative to each other. The plug portion 57 of the communication interface cable 10 passes through a port 32 formed in the rear of the rear housing portion, and interfaces with connector 75 mounted on the PC board 8. Also, shown in FIG. 1, flexible EAS/RFID cable 402 is connected to interface cable 10 using clips or like fasteners all the way to the EAS subsystem module 28 and RFID subsystem module 700, both of which are interfaced to the host computer 91 by way of cables 28F and 705, respectively.

The hand-supportable multi-function code reading system 1 can be used in both hand-supportable and counter-top supportable modes of operation, in manually-triggered and automatically-triggered mode of operation, and for (i) reading optically-encoded symbols (e.g. bar code symbols) 961 and electronically-encoded devices (e.g. RFID tags) 970 and hybrid RFID/EAS tags or labels 972, and (ii) detecting and activating EAS tags 971 that have been applied to objects such as high-valued consumer products 960.

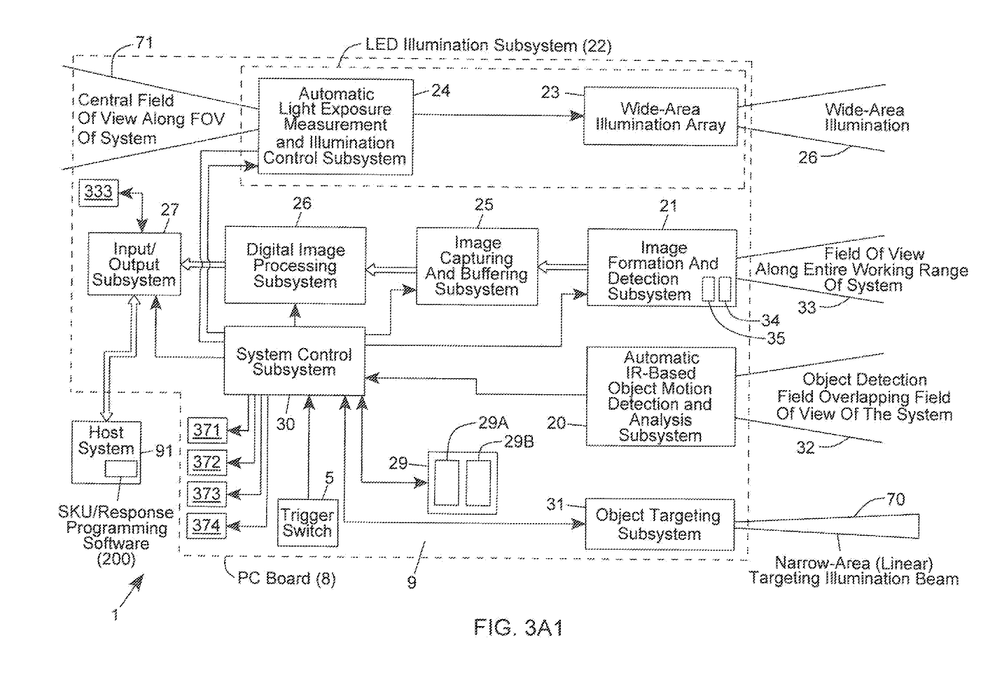

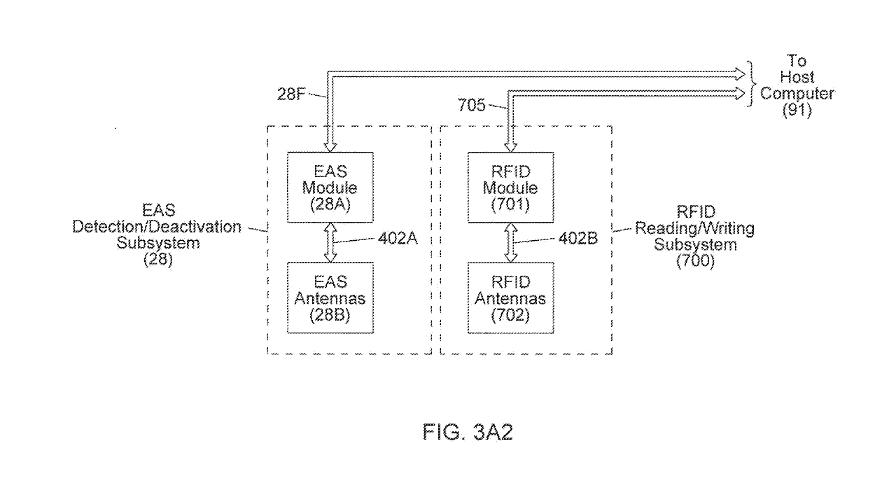

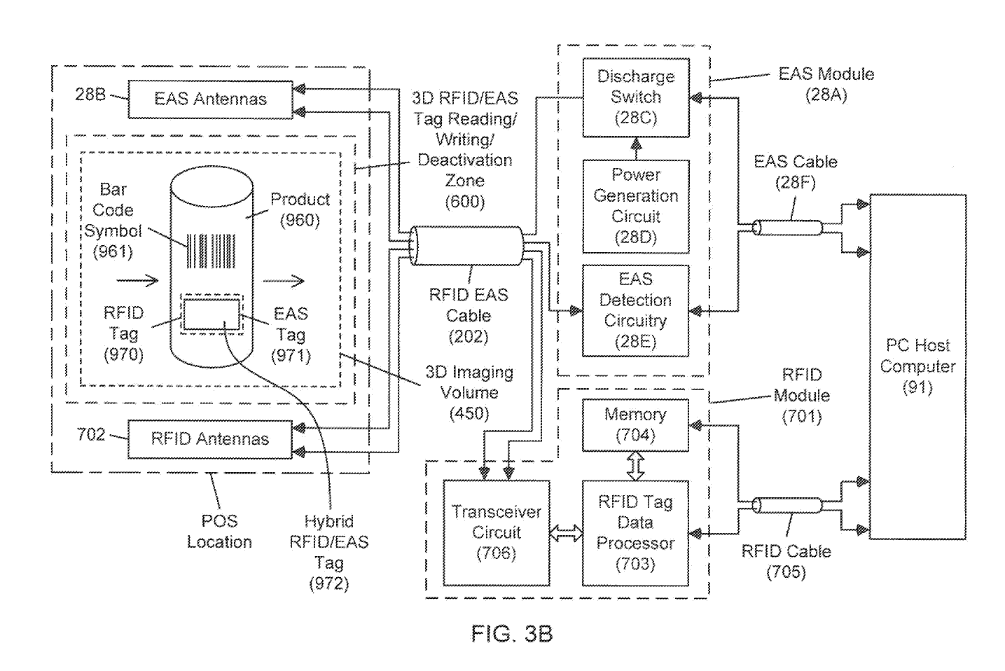

As shown in FIG. 3, the optical and electronic code reading system 1 comprises a number of subsystem components, namely: an image formation and detection (i.e. camera) subsystem 21 having image formation (camera) optics 34 for producing a field of view (FOV) upon an object to be imaged and a CMOS or like area-type image detection array 35 for detecting imaged light reflected off the object during illumination operations in an image capture mode in which at least a plurality of rows of pixels on the image detection array are enabled; a LED-based illumination subsystem 22 employing an LED illumination array 32 for producing a field of narrow-band wide-area illumination 26 within the entire FOV 33 of the image formation and detection subsystem 21, which is reflected from the illuminated object and transmitted through a narrow-band transmission-type optical filter 40 realized within the hand-supportable and detected by the image detection array 35, while all other components of ambient light are substantially rejected; an object targeting illumination subsystem 31 for generating a narrow-area targeting illumination beam 70 into the FOV to help allow the user align bar code symbols within the active portion of the FOV where imaging occurs; an IR-based object motion detection and analysis subsystem 20 for producing an IR-based object detection field 32 within the FOV of the image formation and detection subsystem 21; an automatic light exposure measurement and illumination control subsystem 24 for controlling the operation of the LED-based illumination subsystem 22; an image capturing and buffering subsystem 25 for capturing and buffering 2-D images detected by the image formation and detection subsystem 21; a digital image processing subsystem 26 for processing 2D digital images captured and buffered by the image capturing and buffering subsystem 25 and reading 1D and/or 2D bar code symbols represented therein; an input/output subsystem 27 for outputting processed image data and the like to an external host system or other information receiving or responding device; an electronic article surveillance (EAS) subsystem 28 for generating EAS tag detection and deactivation fields under the supervision of host system 91; an RFID subsystem 700 for generating RFID tag reading and writing fields under the supervision of host system 91; an EAS-enabling faceplate bezel 400, disclosed in co-pending U.S. application ser. No. 13/017,256 filed Jan. 13, 2011, and incorporated herein by reference, embodying the primary subcomponents of the EAS subsystem 28, and RFID subsystem 700 (e.g. EAS antennas 28B, RFID antennas 702 and interface circuit 470 allowing a flexible EAS/RFID cable 402 to pass the interfaces of the EAS module 28A and RFID module 701, as shown in FIG. 1); a system memory 29 for storing data implementing a configuration table 29A of system configuration parameters (SCPs), and a special product/response exception handling procedure table 29B storing special product codes (e.g. UPCs, SKUs and/or EPCs) and related special handling or exception codes or messages; a system control subsystem 30 integrated with the subsystems above, for controlling and/or coordinating these subsystems during system operation; a retail RDBMS server 333 interfaced with the input/output subsystem 27, for supporting POS product pricing and related POS services described hereinafter; and a Bluetooth communication interface, interfaced with I/O subsystem 27, and hand-held scanners, PDAs and the like.

The primary function of the object targeting subsystem 31 is to automatically generate and project a visible linear-targeting illumination beam across the central extent of the FOV of the system in response to either (i) the automatic detection of an object during hand-held imaging modes of system operation, or (ii) manual detection of an object by an operator when s/he manually actuates the manually-actuatable trigger switch 5 (5A, 5B). In order to implement the object targeting subsystem 31, the OCS assembly 78 also comprises a fourth support structure for supporting the pair of beam folding mirrors above a pair of aperture slots, which in turn are disposed above a pair of visible LEDs arranged on opposite sites of the FOV optics 34 so as to generate a linear visible targeting beam 70 that is projected off the second FOV folding 75 and out the imaging window 3, as shown and described in detail in US Patent Publication No. US20080314985 A1, incorporated herein by reference in its entirety.

The primary function of the object motion detection and analysis subsystem 20 is to automatically produce an object detection field 32 within the FOV 33 of the image formation and detection subsystem 21, to detect the presence of an object within predetermined regions of the object detection field 32, as well as motion and velocity information about objects therewithin, and to generate control signals which are supplied to the system control subsystem 30 for indicating when and where an object is detected within the object detection field of the system. As shown in FIG. 2B, IR LED 90A and IR photodiode 90B are supported in the central lower portion of the optically opaque structure 133, below the linear array of LEDs 23. The IR LED 90A and IR photodiode 90B are used to implement the object motion detection subsystem 20 whose function is to automatically detect the presence of objects in the FOV of the system.

The image formation and detection subsystem 21 includes image formation (camera) optics 34 for providing a field of view (FOV) 33 upon an object to be imaged and a CMOS area-type image detection array 35 for detecting imaged light reflected off the object during illumination and image acquisition/capture operations.

The primary function of the LED-based illumination subsystem 22 is to produce a wide-area illumination field 36 from the LED array 23 when an object is automatically detected within the FOV. Notably, the field of illumination has a narrow optical-bandwidth and is spatially confined within the FOV of the image formation and detection subsystem 21 during modes of illumination and imaging, respectively. This arrangement is designed to ensure that only narrow-band illumination transmitted from the illumination subsystem 22, and reflected from the illuminated object, is ultimately transmitted through a narrow-band transmission-type optical filter subsystem 40 within the system and reaches the CMOS area-type image detection array 35 for detection and processing, whereas all other components of ambient light collected by the light collection optics are substantially rejected at the image detection array 35, thereby providing improved SNR, thus improving the performance of the system.

The narrow-band transmission-type optical filter subsystem 40 is realized by (1) a high-pass (i.e. red-wavelength reflecting) filter element embodied within at the imaging window 3, and (2) a low-pass filter element mounted either before the CMOS area-type image detection array 35 or anywhere after beyond the high-pass filter element, including being realized as a dichroic mirror film supported on at least one of the FOV folding mirrors 74 and 75, shown in FIGS. 2A and 2B.

As shown in FIG. 2B, the linear array of LEDs 23 is aligned with an illumination-focusing lens structure 51 embodied or integrated within the upper edge of the imaging window 3. Also, the light transmission aperture 60 formed in the PC board 8 is spatially aligned within the imaging window 3 formed in the front housing portion 2A. The function of illumination-focusing lens structure 51 is to focus illumination from the single linear array of LEDs 23, and to uniformly illuminate objects located anywhere within the working distance of the FOV of the system.

As shown in FIG. 2B, an optically opaque light ray containing structure 50 is mounted to the front surface of the PC board 8, about the linear array of LEDs 23. The function of the optically-opaque light ray containing structure 133 is to prevent transmission of light rays from the LEDs to any surface other than the rear input surface of the illumination-focusing lens panel 3, which uniformly illuminates the entire FOV of the system over its working range. When the front and rear housing panels 2B and 2A are joined together, with the PC board 8 disposed therebetween, the illumination-focusing lens panel 3 sits within slanted cut-away regions formed in the top surface of the side panels, and illumination rays produced from the linear array of LEDs 23 are either directed through the rear surface of the illumination-focusing lens panel 3 or absorbed by the black colored interior surface of the structure 133.

As shown in FIGS. 2A and 2B the optical component support (OCS) assembly 78 comprises: a first inclined panel for supporting the FOV folding mirror 74 above the FOV forming optics, and a second inclined panel for supporting the second FOV folding mirror 75 above the light transmission aperture 60. With this arrangement, the FOV employed in the image formation and detection subsystem 21, and originating from optics supported on the rear side of the PC board, is folded twice, in space, and then projected through the light transmission aperture and out of the imaging window of the system.

The automatic light exposure measurement and illumination control subsystem 24 performs two primary functions: (1) to measure, in real-time, the power density [joules/cm] of photonic energy (i.e. light) collected by the optics of the system at about its image detection array 35, and to generate auto-exposure control signals indicating the amount of exposure required for good image formation and detection; and (2) in combination with the illumination array selection control signal provided by the system control subsystem 30, to automatically drive and control the output power of the LED array 23 in the illumination subsystem 22, so that objects within the FOV of the system are optimally exposed to LED-based illumination and optimal images are formed and detected at the image detection array 35.

As shown in FIG. 2B, the OCS assembly 78 also comprises a third support panel for supporting the parabolic light collection mirror segment 79 employed in the automatic exposure measurement and illumination control subsystem 24. Using this mirror 78, a narrow light collecting FOV is projected out into a central portion of the wide-area FOV 33 of the image formation and detection subsystem 21 and focuses collected light onto photo-detector 81, which is operated independently from the area-type image sensing array, schematically depicted in FIG. 3 by reference numeral 35.

The primary function of the image capturing and buffering subsystem 25 is (1) to detect the entire 2-D image focused onto the 2D image detection array 35 by the image formation optics 34 of the system, (2) to generate a frame of digital pixel data for either a selected region of interest of the captured image frame, or for the entire detected image, and then (3) buffer each frame of image data as it is captured.

Notably, in the illustrative embodiment, the system has both single-shot and video modes of imaging. In the single shot mode, a single 2D image frame (31) is captured during each image capture and processing cycle, or during a particular stage of a processing cycle. In the video mode of imaging, the system continuously captures frames of digital images of objects in the FOV. These modes are specified in further detail in US Patent Publication No. US20080314985 A1, incorporated herein by reference in its entirety.

The primary function of the digital image processing subsystem 26 is to process digital images that have been captured and buffered by the image capturing and buffering subsystem 25, during modes of illumination and operation. Such image processing operations include image-based bar code decoding methods as described in U.S. Pat. No. 7,128,266, incorporated herein by reference.

In FIG. 3, the primary components of the EAS subsystem 28 and RFID subsystem 700 are shown. As shown, EAS subsystem 28 comprises: EAS antennas 28A (e.g. detection/deactivation coil) 28A for generating an EAS tag detection and deactivation fields within a 3D EAS tag detection/deactivation zone 600 that spatially encompasses the 3D imaging volume 450, as shown in FIG. 1; a EAS signal supply and processing unit or module 28A containing a discharge switch 28C, a power generation circuit 28D and a EAS tag detection circuit 28E, in a compact manner. The EAS signal supply and processing module 28A further comprises a standard AC power input and power supply circuit well known in the art. The primary function of the EAS tag detection field is to automatically detect EAS tags applied to priced product items, when such product items are passed through the 3D EAS/RFID tag reading/writing/deactivation zone. The primary function of the EAS tag deactivation field is to automatically deactivate EAS tags applied to purchased product items, when such items are passed through the 3D EAS/RFID tag reading/writing/deactivation zone 600.

As shown, RFID subsystem 700 comprises: RFID antennas (e.g. reading/writing coil) 702 for generating an RFID tag reading and writing field within a 3D RFID/EAS tag reading/writing/detection/deactivation zone 600 that spatially encompasses the 3D imaging volume 450, as shown in FIG. 1; an RFID tag processor (e.g. microprocessor) 703 for executing programs within system memory 704; system memory 704 for storing programs directing (i) the processing of data read from memory within an RFID tag so as to read/recognize code(s) (e.g. UPC, EAN, SKU, or EPC) stored within RFID tag memory and typically identifying the product or object to which the RFID tag is applied, and (ii) the processing of data to be written into memory within an RFID tag so as to identify particular product attributes, conditions, or other events that might have taken place (e.g. product has been successfully purchased at POS); and a signal transceiver circuit 706 interfaced with programmed RFID data processor 703, and in data communication with the RFID antennas 702, by way of RFID/EAS cable 202, shown in FIG. 3B, to transmit and receive digitally modulated signals driving the RFID antennas in accordance with the modulation scheme that may be employed in any given RFID application (e.g. transmitting and receiving UHF modulated signals between an RFID tag and the signal transceiver circuit 706.

As shown in FIG. 2C, EAS antenna coils 28B and RFID antenna coils 700 are connected to the interface circuit 450 which is mounted within the base portion of the bezel structure 400, mounted about the faceplate (i.e. light transmission window) 3 of the system. In turn, flexible EAS/RFID cable 40 is connected to the interface circuit 450, which extends to EAS module 28A and RFID module 701 as shown in FIG. 1.

During EAS tag detection operations, power generation circuit 28D supplies coil 28B with electrical current through discharge switch 28C, under the control of host computer 91, to generate a EAS tag detection field having a magnetic field intensity sufficient to illuminate a EAS tag within the field, so that EAS tag detection/reading circuit 28E can sense changes in field intensity (due to the EAS tag) by processing electrical signals detected by coil 28D, and generates a signal indicative of the detected EAS tag presence in the field. During EAS tag deactivation operations, power generation circuit 28D supplies coil 28B with electrical current through discharge switch 28C, under the control of host computer 91, to generate a EAS tag deactivation field having a magnetic field intensity sufficient to deactivate a EAS tag within the field.

During RFID tag reading operations, the signal transceiver 706 supports the transmission and reception of data communication signals between the RFID tag and the RFID data processor 703, under the control of host computer 91, to read data from memory within the RFID tag, as required for the type of RFID technology employed in any given application. During RFID tag writing operations, the signal transceiver 706 supports the transmission and reception of data communication signals between the RFID tag and the RFID data processor 703, under the control of host computer 91, to write data into memory within the RFID tag, as required for the type of RFID technology employed in any given application.

The primary function of the input/output subsystem 27 is to support universal, standard and/or proprietary data communication interfaces with host system 91 and other external devices, and output processed image data and the like to host system 91 and/or devices, by way of such communication interfaces. Examples of such interfaces, and technology for implementing the same, are given in U.S. Pat. No. 6,619,549, incorporated herein by reference in its entirety.

The primary function of the system control subsystem 30 is to provide some predetermined degree of control, coordination and/or management signaling services to each subsystem component integrated within the system, as shown. While this subsystem can be implemented by a programmed microprocessor, in the preferred embodiments of the present disclosure, this subsystem is implemented by the three-tier software architecture supported on micro-computing platform, described in U.S. Pat. No. 7,128,266, incorporated herein by reference.

The primary function of the manually-actuatable trigger switch 5 (5A,5B) integrated with the housing is to enable the user, during a manually-triggered mode of operation, to generate a control activation signal (i.e. trigger event signal) upon manually depressing the same (i.e. causing a trigger event), and to provide this control activation signal to the system control subsystem 30 for use in carrying out its complex system and subsystem control operations, described in detail herein.

The primary function of the system configuration parameter (SCP) table 29A in system memory is to store (in non-volatile/persistent memory) a set of system configuration and control parameters (i.e. SCPs) for each of the available features and functionalities, and programmable modes of supported system operation, and which can be automatically read and used by the system control subsystem 30 as required during its complex operations. Notably, such SCPs can be dynamically managed as taught in great detail in co-pending US Patent Publication No. US20080314985 A1, incorporated herein by reference.

The primary function of the special product/response exception handling procedure table 29B in system memory 29 is to store unique data files specifying special handling/exception procedures for particular (i.e. special) classes of consumer products offered for sale in the retail environment. Such information files can be simple data files containing multiple lists of product data strings (e.g. UPCs, SKUs or EPCs) and special handling/exception codes linked thereto. Onboard memory storage 29 should be sufficient to allow multiple files to be stored at any given time to handle more than one unique set of numbers (i.e. product codes or SKUs) and their special handling/exception procedures. Whenever a consumer product is scanned, its symbol character data string (UPC or SKU), the microprocessor within scanner automatically checks to see if the scanned product is listed as a special consumer product having a registered special handling/exception procedure registered in the retail database system, and if so, to automatically generate the indicated distinctive exception handling signals designed inform and remind the product handler (e.g. cashier) to take appropriate action at the POS within the retail environment.

In the illustrative embodiment, the retail store manager will use a special database client program to set the special response and handling procedures in the code reading system for each special product code identified by its UPC, SKU or EPC number in the retail database system. The database client will allow the store manager to list all desired UPC, SKU or EPC numbers in a particular class of consumer products (e.g. alcohol products), and corresponding response and handling procedures (e.g. beep duration, frequency and repetition). Then, a PC utility is used to load such special product code and exception handling responses from the retail database system, through the host system, and into the system memory aboard each code reading system deployed on the retailer network.

Preferably, the PC client will perform a number of basic functions: (i) display in an Excel worksheet or like document format, all desired product code numbers in a particular class of consumer products (e.g. alcohol products), and corresponding response and handling procedures (e.g. beep duration, frequency and repetition); (ii) generate an output file in a proper output format; and (iii) load the converted data file into system memory 129 of the code reading system. Optionally, the PC client can be designed to allow the store manager or cashier to modify the particular response codes previously set for particular exception handling events assigned to particular consumer products, and to then load these changes to product and exception handling response codes to the retailer database system, so as to update the same across the entire retailer network. However, it should be kept in mind that there are other alternative methods of creating, managing and loading these special product and exception handling codes into the system memory of each code symbol reading system on the retailer network.

In the illustrative embodiment, product purchases requiring special handling procedures might include, for example, but are not limited to:

(i) EAS tagged products requiring EAS tag deactivation upon product purchase completion;

(ii) alcohol products requiring proof of age (Drivers ID)—age restrictions;

(iii) tobacco products requiring proof of age (Drivers ID)—age restrictions;

(iv) controlled products (e.g. pseudoephedrine) requiring additional customer tracking;

(v) age restricted products (e.g. spray paint, firearms, ammunition) requiring identification;

(vi) product purchases requiring a manager to show up and approve or assist in a product transaction;

(vii) product purchases involving the purchase of services, requiring a special service agent to come to the POS to explain the service contract to the customer (e.g. Apple Care);

(viii) special product purchases requiring store security to assist moving the purchased product out of store inventory; and

(ix) product purchases requiring sales clerk to offer other services to customer, including extended product warranties.

The sales clerk involved in a purchase transaction for any of these special product classes, requiring special responses or handling procedures at the POS, can be alerted visually and/or audibly by way of one or more of the following scanner signaling events: (i) generation of a distinctive audible response (e.g. signals that change tone, duration or count, or songs or speech-type audio messages produced from a suitable audio-transducer 371, and/or distinctive vibrations or razzle sounds produced from within the hand-supportable housing of the scanner by way of an electro-mechanical vibrator 372; and (ii) generation of distinctive light patterns from LEDs 373 mounted on the system housing, or visual messages displayed on a LCD display 374 mounted in, on or through the scanner housing 2A, 2B and connected to the motherboard 8 via a flexible cable or circuit.

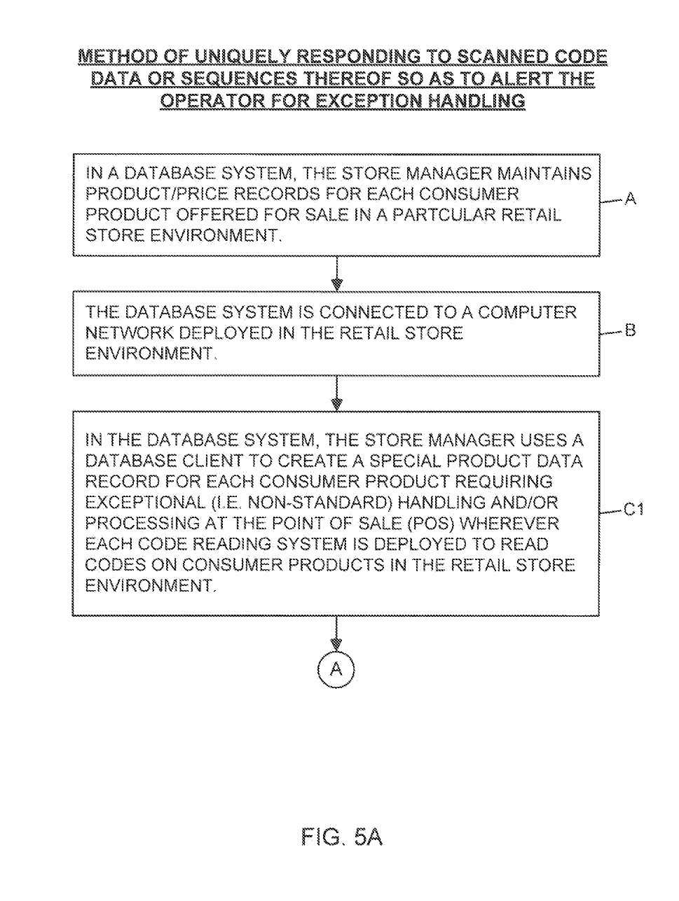

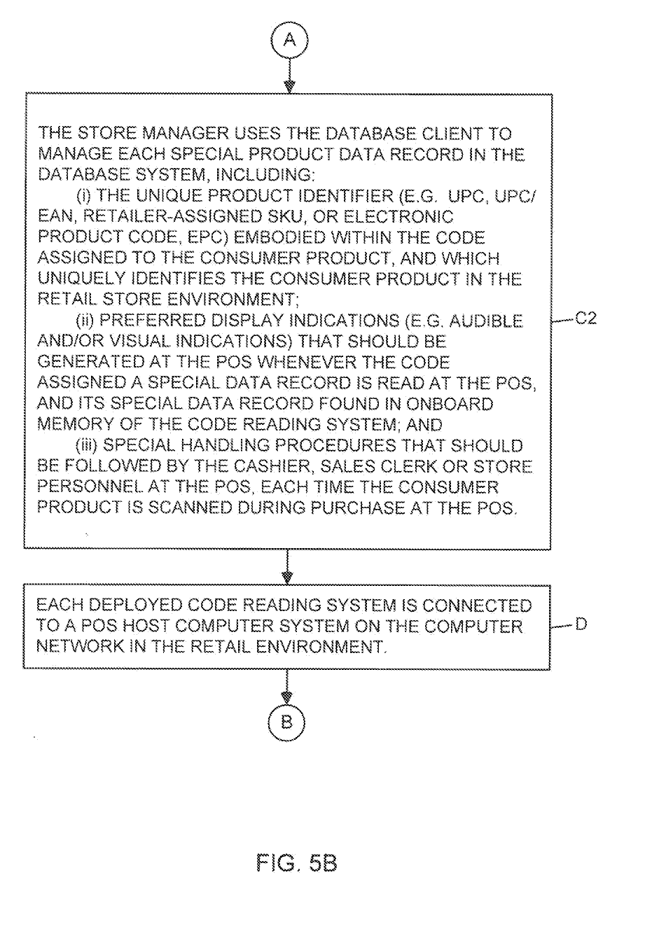

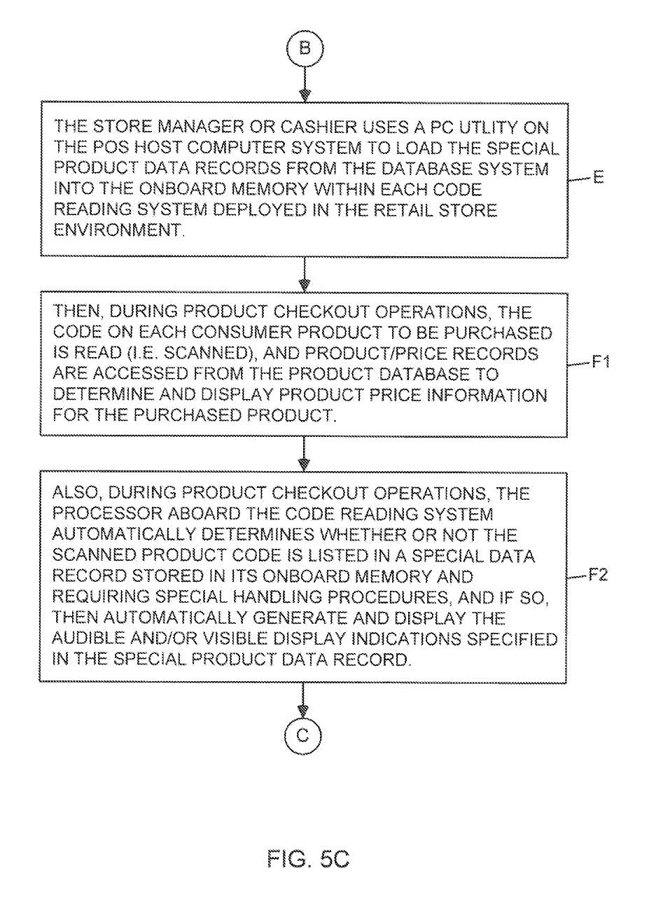

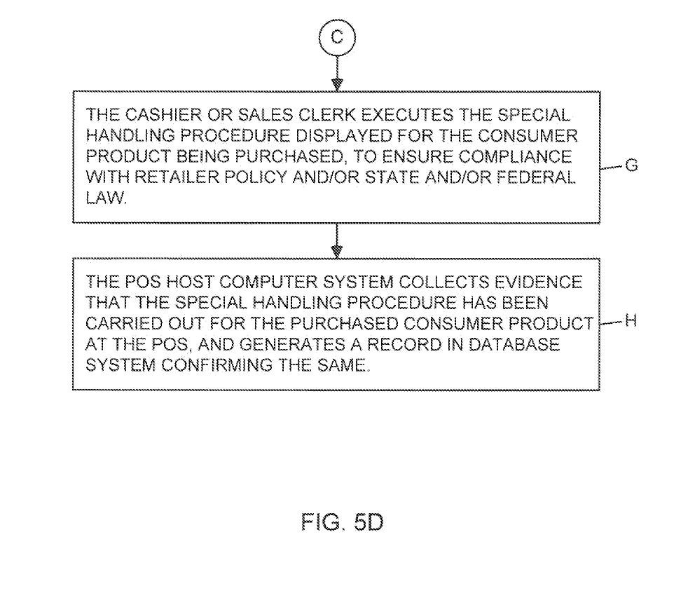

FIGS. 5A through 5C describes the primary steps carried out when practicing the method of programming special product identification codes (e.g. UPC, SKU, or EPC) and responses and handling procedures in a code reading system.

As shown at Block A in FIG. 5A, the store manager manages, in a database system, product/price records for each consumer product offered for sale in a particular retail store environment.

As indicated at Block B, the database system is connected to a computer network deployed in the retail environment.

As indicated at Block C1, the store manager uses a database client to create a special data record, in the database system, for each consumer product requiring exceptional (i.e. non-standard) handling and/or processing at the point of sale (POS) wherever each code reading system is deployed to read codes on consumer products in the retail store environment.

As indicated at Block C2, the store manager uses the database client to manage each special data record in the database system, including:

(i) the unique product identifier (e.g. UPC, UPC/EAN or retailer-assigned SKU) embodied within the code symbol assigned to the consume product, and which uniquely identifies the consumer product in the retail store environment;

(ii) preferred display indications (e.g. audible and/or visual indications) that should be generated at the POS whenever the bar code symbol assigned a special data record is read at the POS, and its special data record found in onboard memory of the bar code reading system; and

(iii) special handling procedures that should be followed by the cashier, sales clerk or store personnel at the POS, each time the consumer product is scanned during purchase at the POS.

In the illustrative embodiment, audio-transducer 371, vibrator 372, LEDs 373 and LCD 374 are provided for the purpose of generating visual and audible indications that signify special handling requirements for a particular consumer product registered within system memory of the code symbol reading system.

As indicated at Block D, each deployed code symbol reading system is connected to the computer network in the retail store environment.

As indicated at Block E, the store manager or cashier uses a PC utility on the host computer system to load the special data records from the database system into the onboard memory within each code symbol reading system deployed in the retail store environment.

As indicated at Block F1, then, during product checkout operations, the code on each consumer product to be purchased is read (i.e. scanned), and product/price records are accessed from the product database to determine and display product price information for the purchased product.

As indicated at Block F2, during product checkout operations, the processor aboard the code reading system determines whether or not the scanned product code is listed in a special data record stored in its onboard memory and requiring special handling procedures, and if so, then automatically generates and displays the audible and/or visible display indications specified in the special data record.

As indicated at Block G, the cashier or sales clerk executes the special handling procedure displayed for the consumer product being purchased, to ensure compliance with retailer policy and/or state and/or federal law.

As indicated at Block H, the host system collects evidence that the special handling procedure has been carried out for the purchased consumer product at the POS, and generates a record in the database system confirming the same.

In the above illustrative embodiment, a database client is used to create and manage the special product records in the retail database system, and then a separate PC utility on the host computer system is used to load these special product records from the database system to the system memory aboard the code reading system. This two-step approach allows the store manager to centrally yet remotely manage the special product records (e.g. UPC, SKU or EPC lists and associated exception handling procedures), and then distribute these special data records to all host computer systems in the retailer network, which are interfaced to a code reading system, in a wired or wireless manner. This technique ensures order and consistency throughout the retail enterprise.

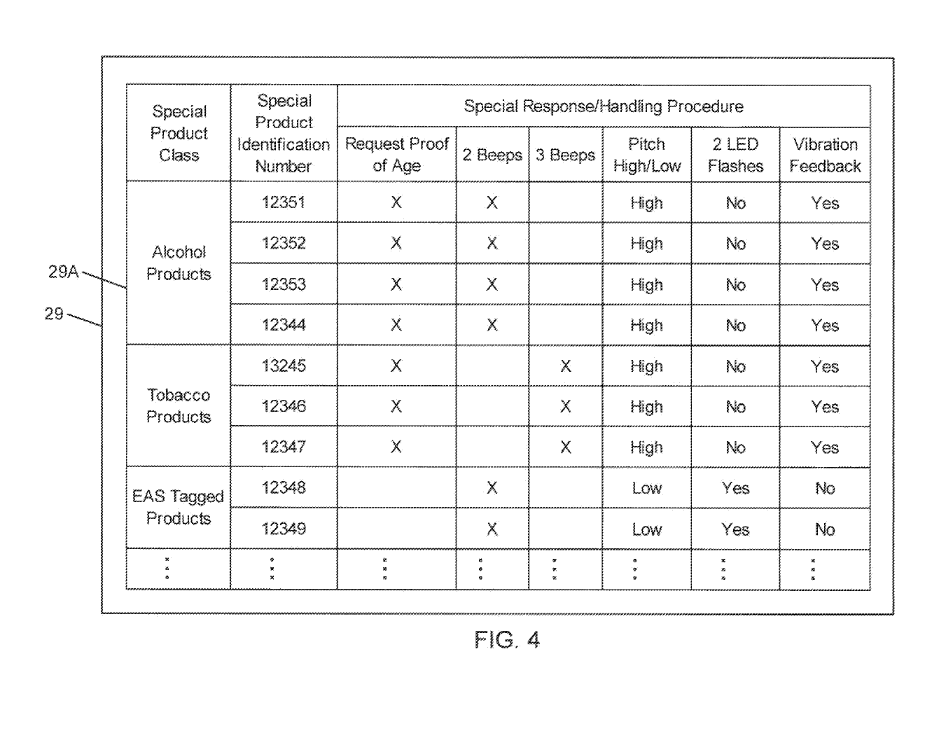

Alternatively, instead of using a database client and a PC utility as described above, a single PC utility can be installed on the host computing system to which a code reading system is interfaced, and the store manager or cashier can load product codes (e.g. UPCs, SKUs, EPCs) from the retailer database system, and then create special product records for particular classes of products, and indicate their special handling procedures, and responses, as indicated in the table shown in FIG. 4. This data file can be in an Excel format, supported on the PC host computing system, and then converted to the proper file format when exported to the code reading system during product data record loading operations into system memory aboard the code reading system.

Alternatively, in lieu of using a PC utility to load the special product records from the database into system memory of the code reading system, a PC utility can be developed for encoding the special product records (from the RDBMS) 333 into one or more high-density 2D bar code symbols, which are then printed on a sheet. Then, the printed 2D bar code symbols can be read by the code reading system, while operating in a programming mode, to load the special product data records into the system memory of the deployed code reading system. Once loaded into system memory, the special product data records can be accessed by the processor aboard the code reading system, during “exception handling” data processing operations described above.

### Second Illustrative Embodiment of the Optical And Electronic Code Reading System of the Present Disclosure

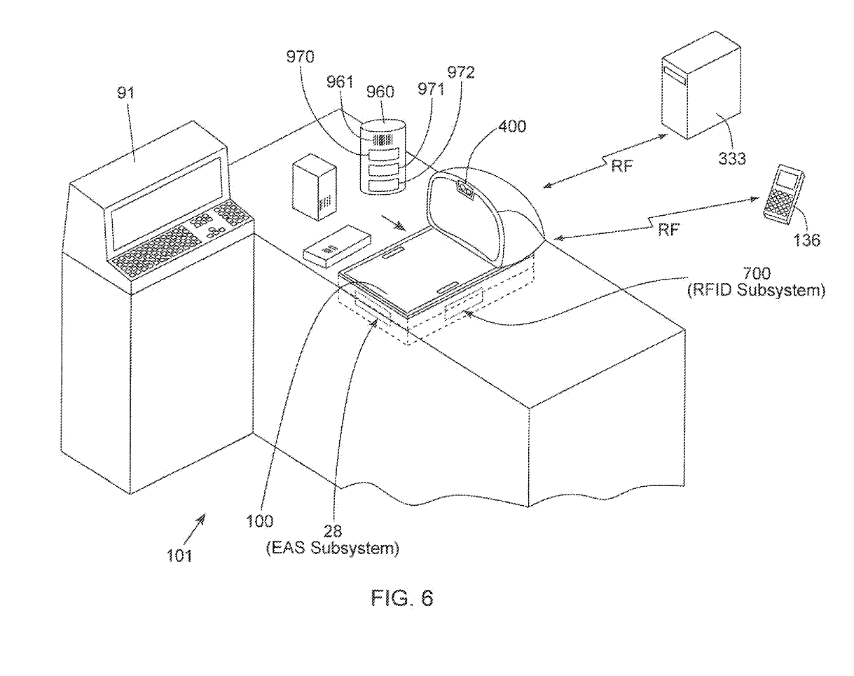

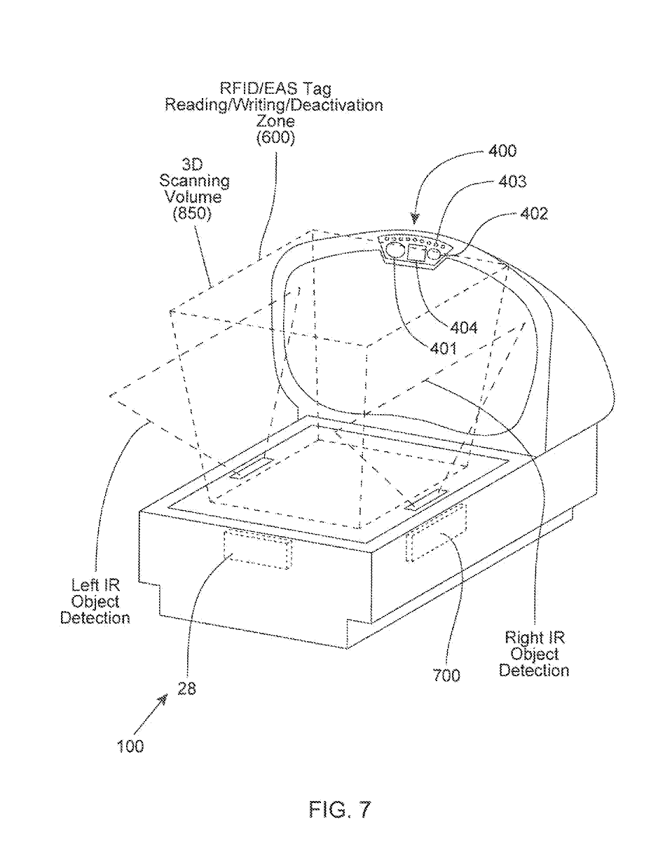

In FIG. 6, a second illustrative embodiment of the multi-function code reading system is shown realized in the form of a POS checkout system 101 employing a bi-optic laser scanning bar code and RFID code reading subsystem 100. In FIG. 7, the system 100 is shown removed from its POS environment, and includes a pair of IR object detection fields 120A and 120B which are projected outside of the limits of the horizontal and vertical scanning windows of the system, and spatially co-incident therewith, for sensing in real-time the motion of coded objects being passing therethrough during system operation. In general, the IR-based object motion detection fields 120A and 120B can be generated in various ways, including from a plurality of IR Pulse-Doppler LIDAR motion/velocity detection subsystems 300 installed within the system housing. In the illustrative embodiments of FIG. 6, multiple IR Pulse-Doppler LIDAR motion/velocity sensing chips (e.g. Philips PLN2020 Twin-Eye 850 nm IR Laser-Based Motion/Velocity Sensor System in a Package (SIP)) can be employed in the system. Details regarding this subsystem are described in US Publication No. 2008/0283611 A1, incorporated herein by reference.

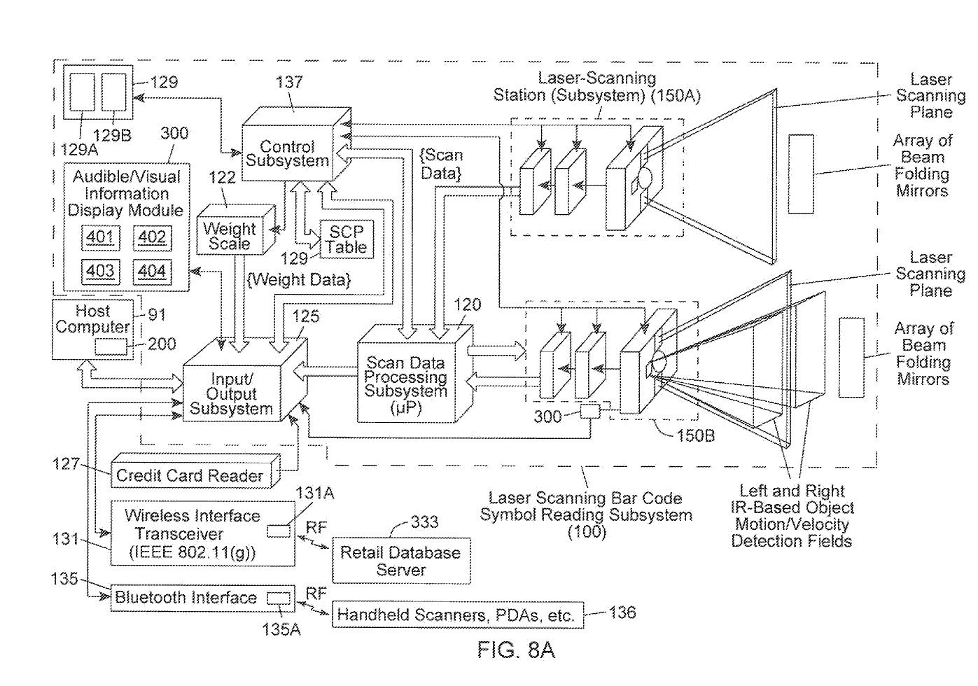

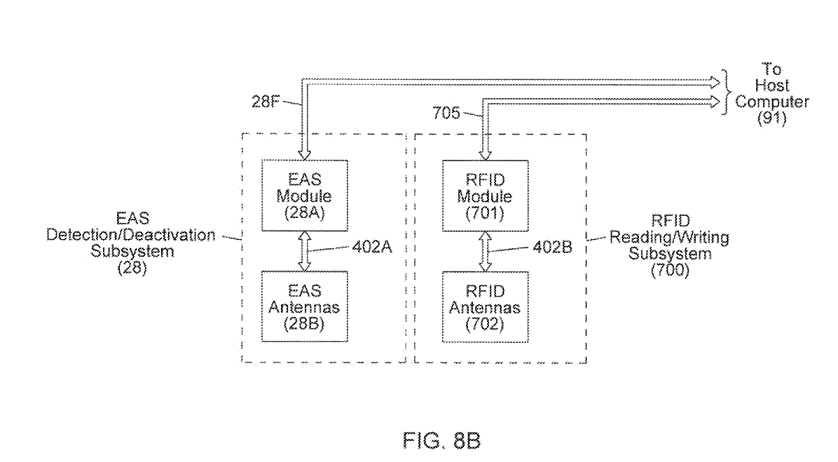

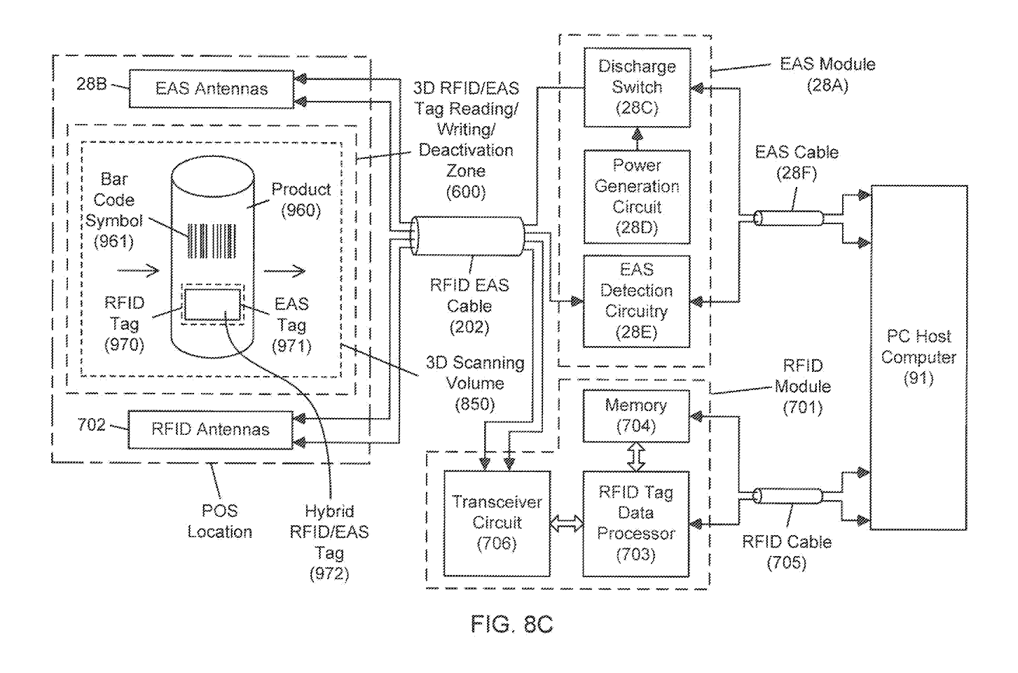

As shown in FIG. 8, the multi-function code reading subsystem 100 comprises: a pair of laser scanning stations (i.e. subsystems) 150A and 150B, for generating and projecting a complex of laser scanning planes into the 3D scanning volume of the subsystem; a scan data processing subsystem 120 for supporting automatic processing of scan data collected from each laser scanning plane in the system; an electronic weight scale 122 employing one or more load cells positioned centrally below the system housing, for rapidly measuring the weight of objects positioned on the window aperture of the system for weighing, and generating electronic data representative of measured weight of the object; an input/output subsystem 125 for interfacing with the image processing subsystem, the electronic weight scale 122, and credit-card reader 127; an EAS subsystem 28 for detecting EAS tags on product items before the products have been checkout (i.e. purchased at the POS-based checkout station) and then deactivating these EAS tags after checkout; an RFID subsystem 700 for reading data from, and writing data to, the memory aboard RFID tags or labels applied to products being moved past the system; a system memory 129 for storing data implementing a table 129A of system configuration parameters (SCPs), and a special product/response exception handling procedure table 129B of special product codes (e.g. UPCs, SKUs or EPCs) and related special handling or exception codes; an audible/visual information display subsystem (i.e. module) 400 for visually and/or audibly displaying various types of indications to the system operator (e.g. cashier) and/or customers product scanning and checkout operations; a wireless interface transceiver (IEEE 802.11(g)) 131; a retail RDBMS server 333 interfaced with transceiver, for supporting POS product pricing and related POS services described hereinafter; and a Bluetooth interface 135, interfaced with I/O subsystem 125, and hand-held scanners, PDAs and the like 136.

The primary function of control subsystem 137 is to orchestrate the various subsystems in the code reading system 100, and also process data inputs and determine that each optically and/or electronically encoded product scanned at the code reading system 100 has been successfully purchased (i.e. paid for), and controlling the deactivation of any EAS tags that might be applied to purchased products, and the like.

The primary function of the system configuration parameter (SCP) table 129A in system memory 129 is to store (in non-volatile/persistent memory) a set of system configuration and control parameters (i.e. SCCPs) for each of the available features and functionalities, and programmable modes of supported system operation, and which can be automatically read and used by the system control subsystem 137 as required during its complex operations. Notably, such SCPs can be dynamically managed as taught in great detail in co-pending US Patent No. US20080314985 A1, incorporated herein by reference.

The primary function of the special product/response exception handling procedure table 129B in system memory 129 is to store unique data files specifying special handling/exception procedures for particular (i.e. special) classes of consumer products offered for sale in the retail environment. Such information files can be simple data files containing multiple lists of product data strings (e.g. UPC, SKUs or EPCs) and special handling/exception codes linked thereto. Onboard memory storage 129 should sufficient to allow multiple files to be stored at any given time to handle more than one unique set of numbers (i.e. product codes) and their special handling/exception procedures. Whenever a consumer product is scanned, its symbol or code character data string (e.g. UPC, SKU or EPC), the microprocessor within code reading system automatically checks to see if the scanned product is listed as a special consumer product having a registered special handling/exception procedure registered in the retail database system, and if so, to automatically generate the indicated distinctive exception handling signals to inform and remind the cashier to make appropriate action at the POS within the retail store environment.

In the illustrative embodiment, the retail store manager will use a special database client program to set the special response and handling procedures in the code symbol reading system for each special product identified by its UPC, SKU or EPC code in the retail database system. The database client will allow the store manager to list all desired SKU numbers in a particular class of consumer products (e.g. alcohol products), and corresponding response and handling procedures (e.g. beep duration, frequency and repetition). Then, a PC utility is used to load such special product code and exception handling responses from the retail database system, through the host system, and into the system memory 129 aboard each code reading system deployed on the retailer network. Preferably, the PC client is realized as a GUI-based SKU configuration tool, running on the host computing system while it is interfaced with the I/O subsystem 127 of the code symbol reading system, by way of an interface driver, as illustrated in FIG. 8.

Preferably, the PC client will perform a number of basic functions: (i) display in an Excel or like document format, all desired SKU numbers in a particular class of consumer products (e.g. alcohol products), and corresponding response and handling procedures (e.g. beep duration, frequency and repetition); (ii) generate an output file in a proper output format; and (iii) load the converted data file into system memory 129 of the code symbol reading system. Optionally, the PC client can be designed to allow the store manager or cashier to modify the particular response codes previously set for particular exception handling events assigned to particular consumer products, and to then load these changes to product and exception handling response codes to the retailer database system, so as to update the same across the entire retailer network. However, it should be kept in mind that there are other alternative methods of creating, managing and loading these special product and exception handling codes into the system memory of each code reading system on the retailer network.

In the illustrative embodiment, product purchases requiring special handling procedures might include, for example, but are not limited to:

(i) EAS tagged products requiring EAS tag deactivation upon product purchase completion;

(ii) alcohol products requiring proof of age (Drivers ID)—age restrictions;

(iii) tobacco products requiring proof of age (Drivers ID)—age restrictions;

(iv) controlled products (e.g. pseudoephedrine) requiring additional customer tracking;

(v) age restricted products (e.g. spray paint, firearms, ammunition) requiring identification;

(vi) product purchases requiring a manager to show up and approve or assist in a product transaction;

(vii) product purchases involving the purchase of services, requiring a special service agent to come to the POS to explain the service contract to the customer (e.g. Apple Care);

(viii) special product purchases requiring store security to assist moving the purchased product out of store inventory; and

(ix) product purchases requiring sales clerk to offer other services to customer, including extended product warranties.

The sales clerk involved in a purchase transaction for any of these special product classes, requiring special responses or handling procedures at the POS, can be alerted visually and/or audibly by way of one or more of the following scanner signaling events: (i) generation of a distinctive audible response (e.g. signals that change tone, duration or count, or songs or speech-type audio messages produced from a suitable audio-transducer 401, and/or distinctive vibrations or razzle sounds produced from within the housing of the code reading system by way of an electro-mechanical vibrator 402; and (ii) generation of distinctive light patterns from LEDs 403 mounted on its housing, or visual messages displayed on a LCD display 404 mounted on its housing.

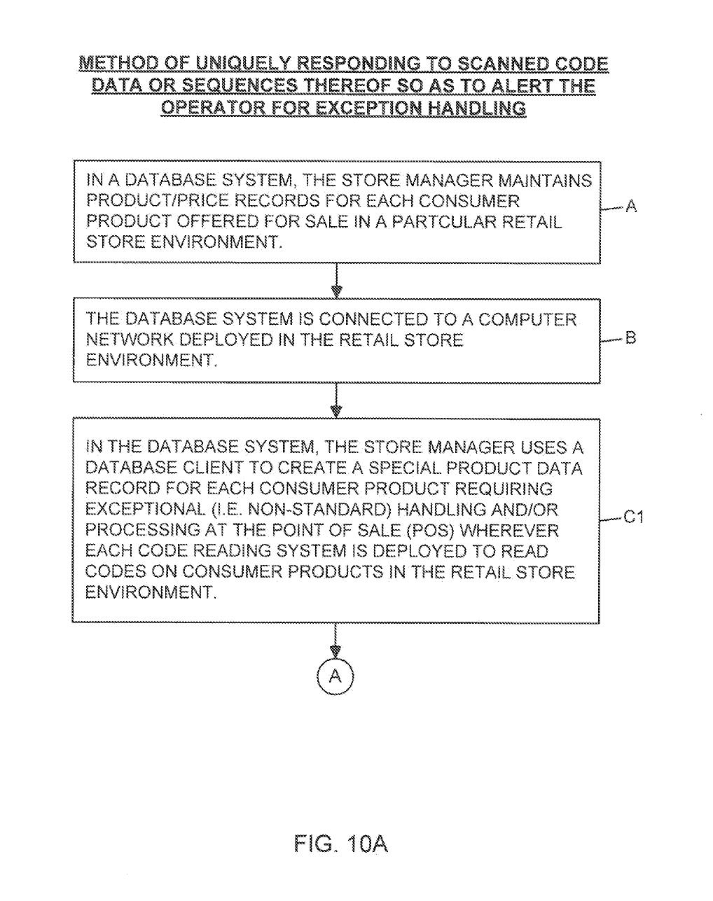

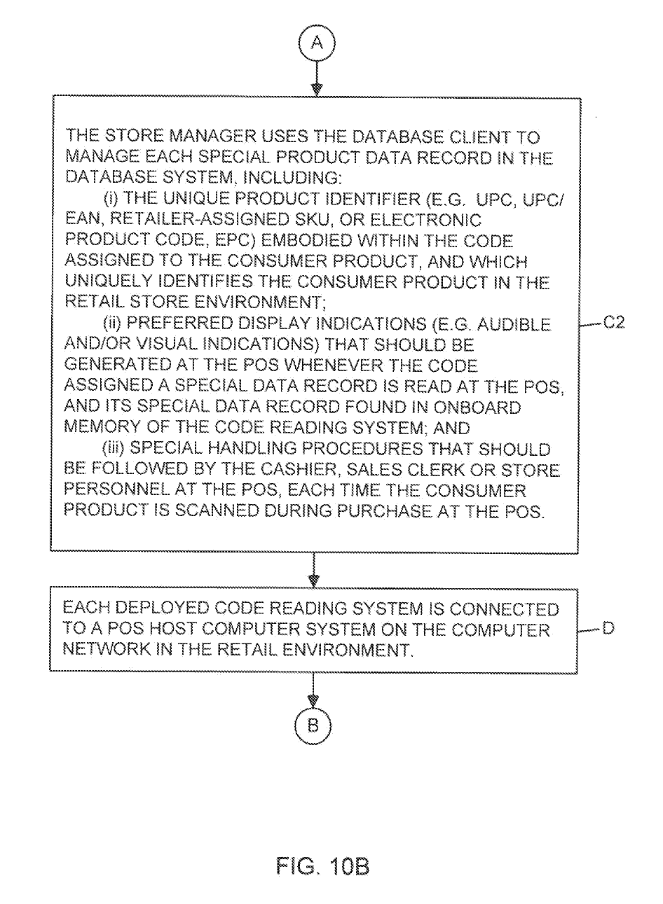

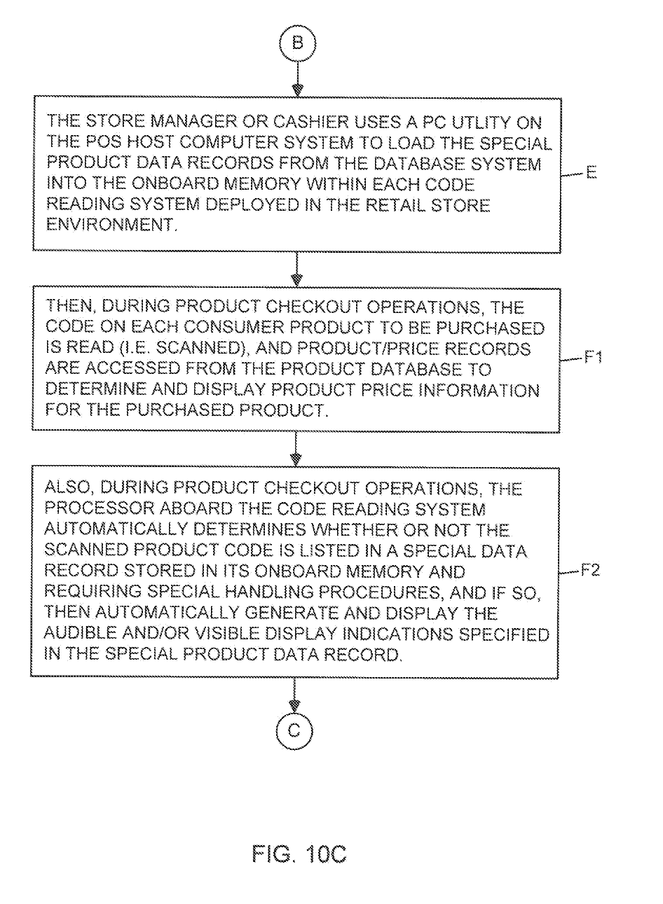

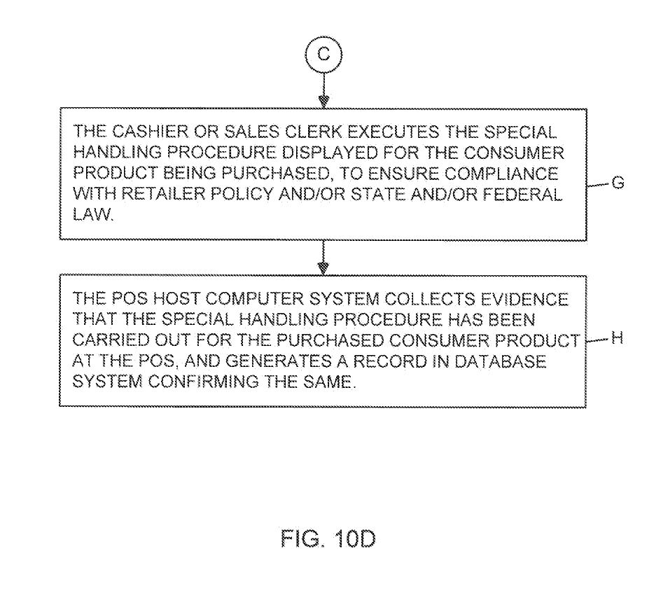

FIGS. 10A through 10C describes the primary steps carried out when practicing the method of programming special UPC, SKU or EPC codes, and responses and handling procedures, in a code reading system.

As shown at Block A in FIG. 10A, the store manager manages, in a database system, product/price records for each consumer product offered for sale in a particular retail store environment.

As indicated at Block B, the database system is connected to a computer network deployed in the retail environment.

As indicated at Block C1, the store manager uses a database client to create a special data record, in the database system, for each consumer product requiring exceptional (i.e. non-standard) handling and/or processing at the point of sale (POS) wherever each code reading system is deployed to read bar code symbols on consumer products in the retail environment.

As indicated at Block C2 in FIG. 10B, the store manager uses the database client to manage each special data record in the database system, including:

(i) the unique product identifier (e.g. UPC, UPC/EAN, retailer-assigned SKU, or EPC) embodied within the code assigned to the consume product, and which uniquely identifies the consumer product in the retail environment;

(ii) preferred display indications (e.g. audible and/or visual indications) that should be generated at the POS whenever the code assigned a special data record is read at the POS, and its special data record found in onboard memory 129 of the code reading system; and

(iii) special handling procedures that should be followed by the cashier, sales clerk or store personnel at the POS, each time the consumer product is scanned during purchase at the POS.

In the illustrative embodiment, audio-transducer 401, vibrator 402, LEDs 403 and LCD 404 are provided for the purpose of generating visual and audible indications that signify special handling requirements for a particular consumer product registered within system memory of the code reading system.

As indicated at Block D, each deployed code symbol reading system is connected to the computer network in the retail environment.

As indicated at Block E in FIG. 10C, the store manager or cashier uses a PC utility on the host computer system to load the special data records from the database system into the onboard memory 129 within each code reading system deployed in the retail store environment.

As indicated at Block F1, then, during product checkout operations, the (bar and/or RFID) code on each consumer product to be purchased is read (i.e. scanned), and product/price records are accessed from the product database to determine and display product price information for the purchased product.

As indicated at Block F2, during product checkout operations, the processor aboard the code reading system determines whether or not the scanned product code is listed in a special data record stored in its onboard memory and requiring special handling procedures, and if so, then automatically generates and displays the audible and/or visible display indications specified in the special data record.

As indicated at Block G, the cashier or sales clerk executes the special handling procedure displayed for the consumer product being purchased, to ensure compliance with retailer policy and/or state and/or federal law.

As indicated at Block H, the host system collects evidence that the special handling procedure has been carried out for the purchased consumer product at the POS, and generates a record in database system confirming the same.

In the above illustrative embodiment, a database client is used to create and manage the special product records in the retail database system, and then a separate PC utility on the host computer system is used to load these special product records from the database system to the system memory 129 aboard the code symbol reading system. This two-step approach allows the store manager to centrally but yet remotely manage the special product records (i.e. UPC, SKU or EPC lists and associated exception handling procedures), and then distribute these special data records to all host computer systems in the retailer network, which are interfaced to a code reading system, in a wired or wireless manner. This technique ensures order and consistency throughout the retail enterprise.

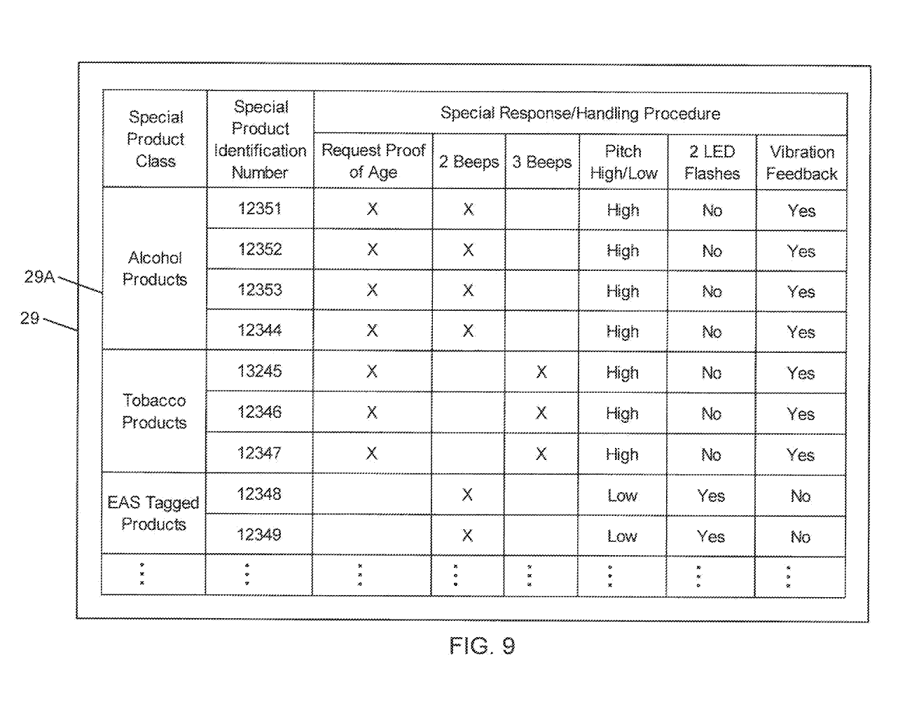

Alternatively, instead of using a database client and a PC utility as described above, a single PC utility can be installed on the host computing system to which a code reading system is interfaced, and the store manager or cashier can load product codes (e.g. UPCs, SKUs or EPCs) from the retailer database system, and then create special product records for particular classes of products, and indicate their special handling procedures, and responses, as indicated in the table shown in FIG. 9. This data file can be in an Excel format, supported on the PC host computing system, and then converted to the proper file format when exported to the code symbol reading system during product data record loading operations into system memory 129 aboard the code symbol reading system.

Alternatively, in lieu of using a PC utility to load the special product records from the database into the system memory 129 of the code reading system, a PC utility can be developed for encoding the special product records (from the RDBMS) into one or more high-density 2D bar code symbols, which are then printed on a sheet. Then, the printed 2D bar code symbols can be read by the bar code symbol reader, while operating in a programming mode, to load the special product data records into the system memory of the deployed code symbol reading system. Once loaded into system memory 129, the special product data records can be accessed by the processor aboard the code symbol readings system, during “exception handling” data processing operations described above.

### Third Illustrative Embodiment of the Optical and Electronic Code Reading System of the Present Disclosure

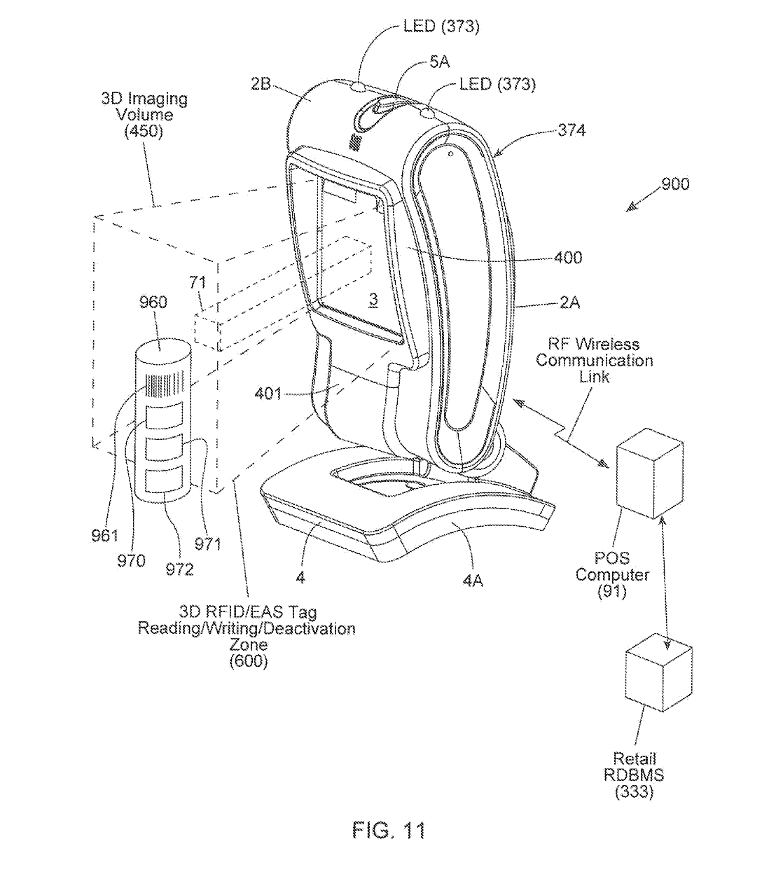

FIG. 11 shows a third illustrative embodiment of a fully mobile wireless hand-supportable optical and electronic code reading system, 900 supporting automatic generation of distinctive exception handling signals from multiple sources within the system housing, while maintaining wireless two-way digital data communication with host computer 91, or base station, connected to a network on which the product database 333 is connected. In this alterative embodiment, the EAS module 28, RFID module 700 and rechargeable battery pack 905 and a wireless RF data communication module (e.g. Bluetooth communication interface) with antennas, are integrated into the base module 4A, mounted beneath base portion 4, without adding significantly to the size or weight of the system.

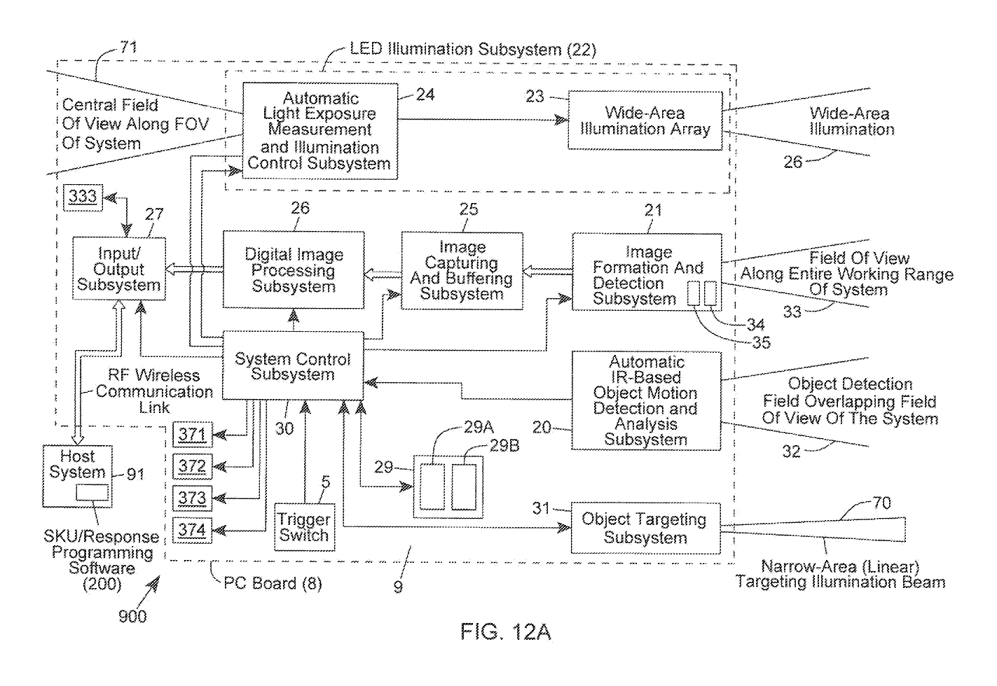

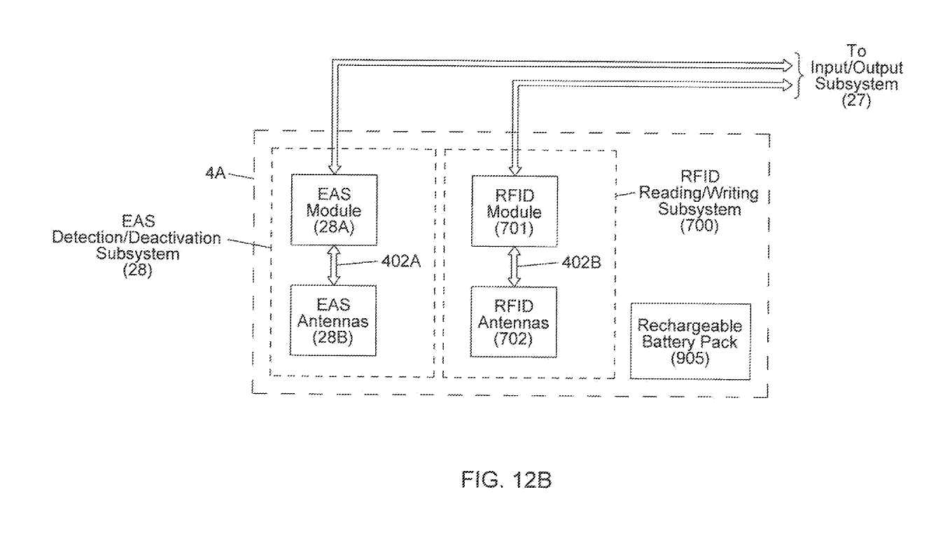

As shown in FIGS. 11, 12A and 12B, the RFID/EAS cable 402 is eliminated, and the wireless RF data communication module, in communication with the input/output subsystem 27, provides the mobile system 1′ with the capacity of supporting robust long-range two-way digital data communication with the remote host system 91, or one or more base stations supporting the same wireless communication interface, and operably connected to the communication network in which the mobile system 900 is a mobile network node. So equipped, mobile multi-function code reading system 900 has the advantage of supporting the reading of 1D, 2D and datamatrix codes, as well as RFID codes, and also detecting and deactivating EAS tags and labels, virtually anywhere in diverse application environments. This system can be used to carry out the two-factor authentication process of the present disclosures described in FIGS. 10A through 10C, at point of sale locations which can be stationary or mobile within diverse environments.

### Some Modifications Which Readily Come to Mind

While the illustrative embodiments have been described in connection with various types of optical code reading applications involving 1-D and 2-D bar code structures and electronic code reading involving RFID tags labels and removable devices, it is understood however that the multi-function code reading system of the present disclosure can be use to: (i) optically read (i.e. recognize) any machine-readable indicia, dataform, or graphically-encoded form of intelligence, including, but not limited to bar code symbol structures, alphanumeric character recognition strings, handwriting, and diverse dataforms currently known in the art or to be developed in the future; and also (ii) electronically read (i.e. recognize) any electronically-encoded form of intelligence, including but not limited to RFID tags, labels and like devices currently know in the art or to be developed in the future. Also, hereinafter and in the Claims, the term “code” shall be deemed to include all such optical and electronic information carrying structures and other forms of encoded intelligence.

Also, while the illustrative embodiments show the use of the system and method of the present disclosure in a retail environment, it is understood that the system and method can be practiced in diverse application environments.

For example, a logistics company can use the system and method when handling packages or products along a supply chain. In such an application, the product handler/sorter can use the code reading system of the present disclosure to read codes on products or packages being sorted, and in response to reading each code (e.g. 2D bar codes and/or RFID tags) automatically parsing, in real-time, the 2D bar code and/or RFID code information, and based on the State, serial number and/or address information, the code symbol reading system can automatically access its system memory (updated from a remote database) and generate unique exception handling signals (e.g. beep patterns) to provide quick audible feedback to the handler/sorter on how to respond to exception handling (e.g. where to place the package for routing operations). Of course, many other applications of the system and method of the present disclosure will readily come to mind to those having the benefit of the present disclosure.

Several modifications to the illustrative embodiments have been described above. It is understood, however, that various other modifications to the illustrative embodiment will readily occur to persons with ordinary skill in the art. All such modifications and variations are deemed to be within the scope of the accompanying Claims.

1. A code reading system for use in a work environment, said code reading system comprising:
a system housing;
a code reading subsystem, disposed in said system housing, for reading codes on products being handled in said work environment, and producing data representative of said read codes for use in handling said products in said work environment;
system memory disposed in said system housing;
one or more signal sources, integrated with or disposed in said system housing, for generating distinctive visual and/or audible exception handling signals indicating special exception handling of particular products being handled in said work environment;
a special product/response and exception handling table stored in said system memory, disposed in said system housing, for storing one or more lists of (i) consumer indicative of procedures to be carried out by a handler in response to perceiving said distinctive visual and/or audible signals indicating special exception handling of particular products being handled in said work environment; and
a system controller, disposed in said system housing, for controlling and/or coordinating said code reading system,
wherein, in response to reading the code on each product in said work environment, said system controller automatically determines whether or not the read code corresponds to a product code listed in said special product/response and exception handling table, and
wherein, in the event that the read code corresponds to a product code stored in said special product/response and exception handling table, then said system controller accesses the special exception handling response code associated with the read code, and generates the distinctive visual and/or audible signals indicated by said special exception handling code, to inform the handler to carry out a special handling procedure indicated out at said POS in accordance with retail store policy and/or state and federal law.

2. The code reading system of claim 1, wherein said handler is a cashier, wherein said work environment is a retail store environment, wherein said products are consumer products offered for sale in said retail store environment, and wherein said distinctive visual and/or audible exception handling signals are generated from said one or more signal sources within said system housing, for special classes of products selected from the group consisting of: EAS tagged products requiring EAS tag deactivation upon product purchase completion: alcohol products requiring proof of age; tobacco products requiring proof of age; controlled products requiring additional customer tracking; age restricted products requiring identification; product purchases requiring a manager to show up and approve or assist in a product transaction; product purchases involving the purchase of services, requiring a special service agent to come to the POS to explain the service contract to the customer; special product purchases requiring store security to assist moving the purchased product out of store inventory; and product purchases requiring sales clerk to offer other services to customer, including extended product warranties.

3. The code reading system of claim 1, wherein distinctive visual and/or audible exception handling signals are generated from said one or more signal sources within said system housing, so as to indicate one or more of following signaling events: (i) generation of an audible response including signals that change tone, duration or count, or songs or speech-type audio messages produced from a suitable audio-transducer; (ii) generation of vibrations or razzle sounds produced from within the said system housing by way of an electro-mechanical vibrator; and (iii) generation of light patterns from LEDs mounted on said system housing, or visual messages displayed on a LCD display mounted on or integrated with said system housing.

4. The code reading system of claim 1, wherein retail personal uses a PC utility program to set the special response and handling procedures in said code reading system for each special product identified by its special product code.

5. The code reading system of claim 1, wherein said code reading subsystem comprises a digital image detector for detecting digital images of said products, and an image processor for processing said digital images to read one or more code symbols on said products and producing symbol character data representative of said read code symbols.

6. The code reading system of claim 6, wherein said code symbol is selected from the group consisting of 1D bar code symbologies, 2D bar code symbologies, and dataforms.

7. The code reading system of claim 1, wherein said code reading subsystem comprises a laser scanning mechanism for scanning a laser beam across objects, reading one or more code symbols on said products and producing symbol character data representative of said read code symbols.

8. The code reading system of claim 7, wherein said code symbol is selected from the group consisting of 1D bar code symbologies, 2D bar code symbologies, and dataforms.

9. The code reading system of claim 1, wherein said code reading subsystem comprises an electronic code reading mechanism for electronically reading an electronically-encoded code within a memory structure contained in a device affixed to said products and producing code data representative of said read codes.

10. The code reading system of claim 9, wherein said electronic code reading mechanism is an RFID code reading subsystem for electronically reading codes within the memory structure contained in an RFID device affixed to said products and producing code data representative of said read codes.

11. The code reading system of claim 1, which further comprises an automatic object detection subsystem for detecting the presence of said consumer product in the vicinity of said system housing.

12. The code reading system of claim 1, wherein said system housing is a hand-supportable housing.

13. The code reading system of claim 12, wherein said hand-supportable housing is wirelessly interfaced with a host computing system.

14. The code reading system of claim 1, wherein said system housing is a stationary housing installed in or supported on a countertop or like surface.

15. The code reading system of claim 1, wherein said system memory comprises EPROM.

16-32. (canceled)
